(19) United States
(12) Patent Application Publication
(10) Pub. No.: US 2007/0080646 A1
(43) Pub. Date: Apr. 12, 2007

(54) FLAT DISPLAY UNIT

(76) Inventors: Masahiro YOKOTA, Fukaya-shi (JP); Hirotaka Murata, Fukaya-shi (JP); Takashi Nishimura, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/608,260

(22) Filed: Dec. 8, 2006

Related U.S. Application Data
(63) Continuation of application No. PCT/JP05/09541, filed on May 25, 2005.

(30) Foreign Application Priority Data
Jun. 18, 2004 (JP) 2004-180954

(51) Int. Cl. G09G 3/10; H01J 63/04; H01J 1/62

(52) U.S. Cl. 315/169.2; 313/495; 313/497

(57) ABSTRACT

An SED is formed by sealing a front-side substrate provided with an image display area having a fluorescent layer on its inside surface, and a back-side substrate provided with a plurality of electron-emitting elements and driving wires for driving the electron-emitting elements, through a rectangular frame-like sidewall. On the outside of the image display area of the front-side substrate, frame-like power supply wiring to apply a high voltage to the image display area through a metal back is formed. In the area of the back-side substrate opposite to the power supply wiring, a bypass member to function as a lightning rod is provided electrically independent of a lower wire.

### CROSS REFERENCE TO RELATED APPLICATIONS

This is a Continuation Application of PCT Application No. PCT/JP2005/009541, filed May 25, 2005, which was published under PCT Article 21(2) in Japanese.

This application is based upon and claims the benefit of priority from prior Japanese Patent Application No. 2004-180954, filed Jun. 18, 2004, the entire contents of which are incorporated herein by reference.

### BACKGROUND OF THE INVENTION

1. Field of the Invention

The present invention relates to a flat display unit, which has a flat-panel vacuum enclosure, and excites and lights a fluorescent layer provided on a front-side substrate by emitting electrons from electron-emitting elements provided on a rear-side substrate.

2. Description of the Related Art

Recently, a flat display unit such as a field emission display (FED) and a plasma display (PDP) has become known as a display unit having a flat-panel vacuum enclosure. As a kind of FED, a surface-conduction electron-emitter display (hereinafter called an SED) having surface conduction electron-emitting elements has been developed.

An FED and an SED have a front-side substrate and a back-side substrate, which are opposed across a predetermined clearance. These substrates are joined along the peripheral edge portion by means of a glass sidewall formed like a rectangular frame, thereby constituting a flat-panel vacuum enclosure whose interior is evacuated.

On the inside surface of the front-side substrate, a fluorescent screen including three color florescent layers is formed. On the inside surface of the back-side substrate, a plurality of electron-emitting elements each corresponding to a pixel are arranged as electron emission sources to excite and light the fluorescent layers. On the inside surface of the back-side substrate, a plurality of wires is provided in a matrix form to drive the electron-emitting elements, and the ends of the wires are brought to the outside of the vacuum enclosure.

To operate the FED and SED, a high voltage is applied to the fluorescent screen, and a driving voltage selectively applied to each electron emitting-element through a driving circuit connected to the driving wires. An electron beam is emitted selectively from each electron-emitting element, accelerated by a high voltage given to the fluorescent layer, and applied to a corresponding fluorescent layer. The fluorescent layer is selectively excited and lit, and a color image is displayed.

In such an FED and SED, since a high voltage to accelerate an electron beam is applied to the fluorescent screen of the front-side substrate, a problem of electric discharge between the front-side substrate and back-side substrate arises. If a discharge occurs, a large current flows through a discharging area, and an electron-emitting element is damaged.

Therefore, it is important to suppress discharge current to prevent damage caused by a discharge. A technique developed to solve this problem is disclosed in Jpn. Pat. KOKAI Publication No. 10-326583.

In the disclosed technique, a metal back is divided, a common electrode (a power supply wiring in the present invention) is provided outside an image display area, and the divided metal back is connected to a common electrode through a connection resistor. In this configuration, discharge current is controlled, and power supply is ensured.

However, in this configuration, the discharge current control effect is limited to the divided metal back area, and is substantially ineffective outside the image display area, particularly for a discharge close to the common electrode. Electron-emitting elements are not provided outside the back-side substrate area opposite to the image display area, but driving wires connected to electron-emitting elements are present. Therefore, if a discharge occurs, an electron-emitting element is damaged through its driving wire. In addition, the driver IC for driving may also be damaged. For perfect prevention of damage by an electric discharge, it is also necessary to take measures against a discharge outside the image display area. However, in principal, it is difficult to suppress a discharge current outside the image display area. Therefore, a countermeasure has been demanded.

### BRIEF SUMMARY OF THE INVENTION

It is an object of the invention to provide a flat display unit, which can prevent damage by an electric discharge occurring close to power supply wiring.

To attain the object, a flat display unit of this invention, in which a front-side-substrate having on its inside surface a fluorescent screen including a fluorescent layer and divided metal backs formed on the fluorescent layer, power supply wiring arranged outside an image display area provided with the fluorescent layer, and a connection resistor for connecting the power supply wiring to the divided metal backs, is opposed to a back-side substrate having on its inside surface an electron-emitting element and a driving wire for driving the electron-emitting element, which are opposed across a predetermined clearance and sealed in the peripheral edge portion; and the interior is evacuated, wherein an insulation layer to cover the driving wire is provided in an area of the back-side substrate opposite to the power supply wiring.

According to the invention, as an insulation layer to cover a driving wire to drive an electron-emitting element is provided in an area of a back-side substrate opposite to a power supply wiring to supply electric potential to an image display area provided with a fluorescent layer, an electric discharge between the power supply wiring and driving wire is controlled, and damage to an electron-emitting element connected to the driving wire is prevented.

In the above flat display unit of the invention, a bypass member is further provided on an insulation layer to cover the driving wire in an area opposite to the power supply wiring to supply electric potential. By functioning the bypass member as a lightning rod, it is securely prevented that an excess current caused by an electric discharge flows in the driving wire.

### BRIEF DESCRIPTION OF THE SEVERAL VIEWS OF THE DRAWING

FIG. 1 is a perspective external view of SED according to an embodiment of the invention;

FIG. 2 is a partially enlarged sectional view of the SED of FIG. 1 taken along lines II-II;

FIG. 3 shows a wiring structure of a metal back;

FIG. 4 shows a rectangular form of a metal back;

FIG. 5 is a partially enlarged cross section for explaining a discharge control structure according to a first embodiment of the invention;

FIG. 6 is a partially enlarged cross section of a modification of the structure of FIG. 5;

FIG. 7 is a partially enlarged cross section for explaining a discharge control structure according to a second embodiment of the invention;

FIG. 8 is a view for explaining a structure of a bypass member; and

FIG. 9 is a partially enlarged cross section for explaining a modification of the invention explained in FIG. 7.

### DETAILED DESCRIPTION OF THE INVENTION

Hereinafter, embodiments of the invention will be explained in detail with reference to the accompanying drawings.

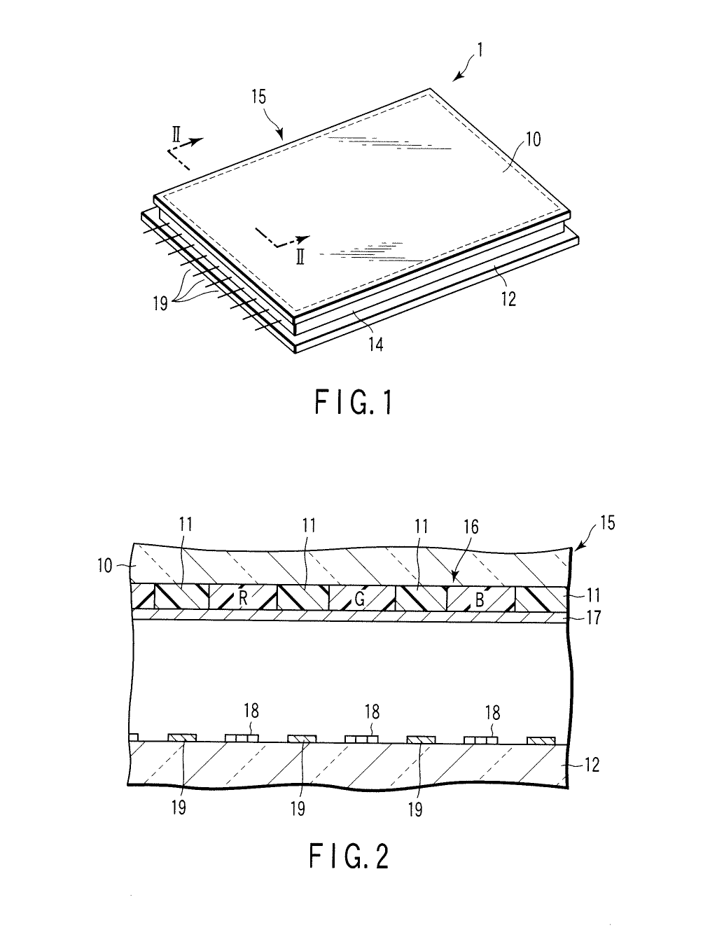

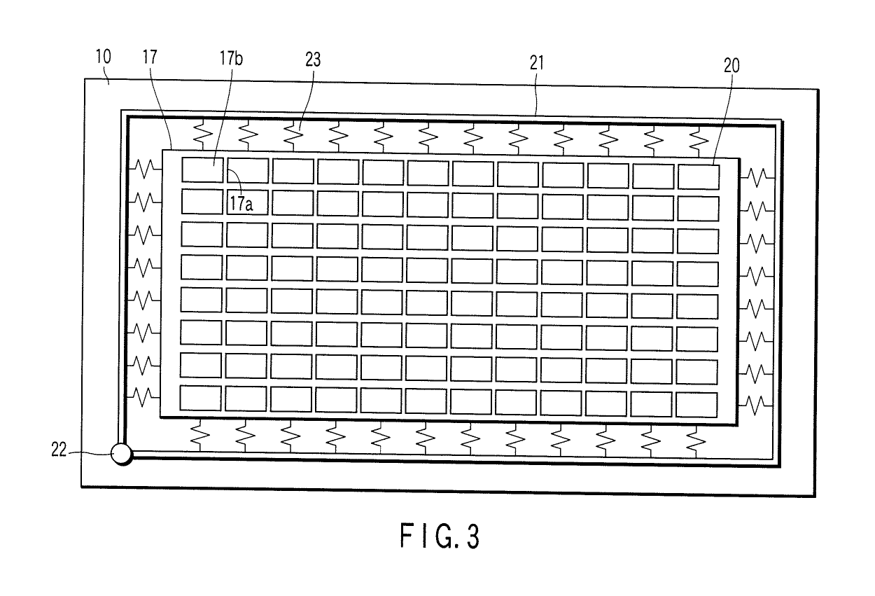

First, an SED will be explained as an example of a flat display unit according to an embodiment of the invention with reference to FIG. 1 to FIG. 3. FIG. 1 is a perspective external view of SED. FIG. 2 is a partially enlarged cross section of the SED of FIG. 1. FIG. 3 is a schematically view of a wiring structure of a metal back 17 described later.

As shown in FIG. 1, SED has a front-side substrate 10 and a back-side substrate 12, each of which is made of a square glass plate. The substrates are opposed parallel with a clearance of 1.0-2.0 mm taken therebetween. The front-side substrate 10 and back-side substrate 12 are joined in the peripheral edge portion through a sidewall 14 made of glass and formed like a rectangular frame, constituting a flat-panel vacuum enclosure 15 whose interior is evacuated.

As shown in FIG. 2, on the inside surface of the front-side substrate 10, a fluorescent screen 16 to function as an image display area is formed. The fluorescent screen 16 is formed by arranging red, blue and green fluorescent layers R, G and B, and a light-shielding layer 11, side by side. These fluorescent layers are arranged in columns and rows. On the fluorescent screen 16, a metal back 17 made, for example, of aluminum is formed. The fluorescent screen 16 and metal back 17 function as the fluorescent screen of the invention.

On the inside surface of the back-side substrate 12, a plurality of surface conduction electron-emitting elements 18 to emit electron beams is provided as electron emission sources to emit electrons to excite and light the fluorescent layers R, G and B of the fluorescent screen 16. These electron-emitting elements 18 are arranged in columns and rows corresponding to each pixel, or each of the fluorescent layers R, G and B. Each electron-emitting element 18 consists of a not-shown electron-emitting part, and a pair of element electrodes to apply a voltage to the electron-emitting part.

On the inside surface of the back-side substrate 12, a number of driving wires 19 for applying a driving voltage to each electron-emitting element 18 is provided in a matrix form, and the end of each wire is brought to the outside of the vacuum enclosure 15.

As shown in FIG. 3, on the inside surface of the front-side substrate 10, a power supply wiring 21 is provided to supply a high voltage to the image display area 20 in which all fluorescent layers R, G and B are arranged, through the metal back 17. In this embodiment, the metal back 17 is electrically divided into rectangular areas 17b by high resistors 17a arranged in a matrix form, and functions as a divided metal back. The power supply wiring 21 is provided like a rectangular frame on the outside of the metal back 17 in order to supply a high voltage evenly to all areas 17b of the metal back 17. The power supply wiring 21 is set to a relatively low resistance so that the resistance at a portion farthest from a power supply point 22 is less than 1 kΩ, in order to decrease its own voltage drop when supplying a high voltage.

More than one connection resistor 23 with a resistance of 0.1-10 MΩ is provided along the peripheral edge of the metal back 17, between the metal back 17 and power supply wiring 21. The power supply point 22 of the power supply wiring 21 is taken out to the outside of the vacuum enclosure 15, and connected to a not-shown high voltage generator through a not-shown wiring.

When displaying an image in the above SED 1, an anode voltage is applied to the metal back, or the image display area 20 through the power supply wiring 21, and driving voltages are applied to the element electrodes of the electron emitting-elements 18 through the driving wires 19, so that electron beams are emitted from the electron beam emitting-parts of the optional electron-emitting elements 18. The electron beams emitted from the electron emitting-parts are accelerated by the anode voltage, and collide with the fluorescent screen 16. Therefore, the R/G/B fluorescent layers of the fluorescent screen 16 are selectively excited and lit, and a color image is displayed on the screen.

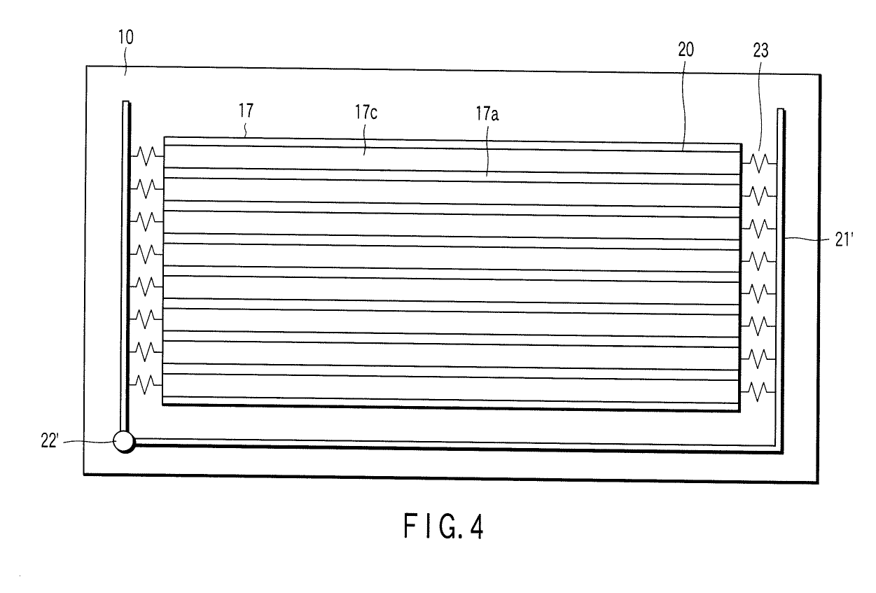

FIG. 4 shows another embodiment example, in which the metal back 17 is electrically divided into strip areas 17c. In this case, a power supply wiring 21′ is provided such that it encloses the image display area 20, along three sides of the front-side substrate 10 except the upper-end side, so as to apply potential from the left and right ends of the strip area 17c. Connection resistors 23 are provided only at the left and right ends of the image display area 20. As a discharge current control effect depends on a dividing form and a withstand voltage among divisions, resistance values among the areas are not even but need to be larger than approximately 1 kΩ.

As the metal back 17 is divided as above described, when an electric discharge occurs in the image display area 20, the discharge is divided into small areas 17b and 17c, and a discharge current can be restricted and damage prevented.

As the divided areas 17b and 17c of the metal back 17 are connected to the power supply wirings 21 and 21′ through the connection resistor 23, when an electric discharge occurs in theses areas, a discharge current flows from the metal back 17 of all areas of the image display area 20 through the power supply wirings 21 and 21′, and a discharge effect control function does not operate.

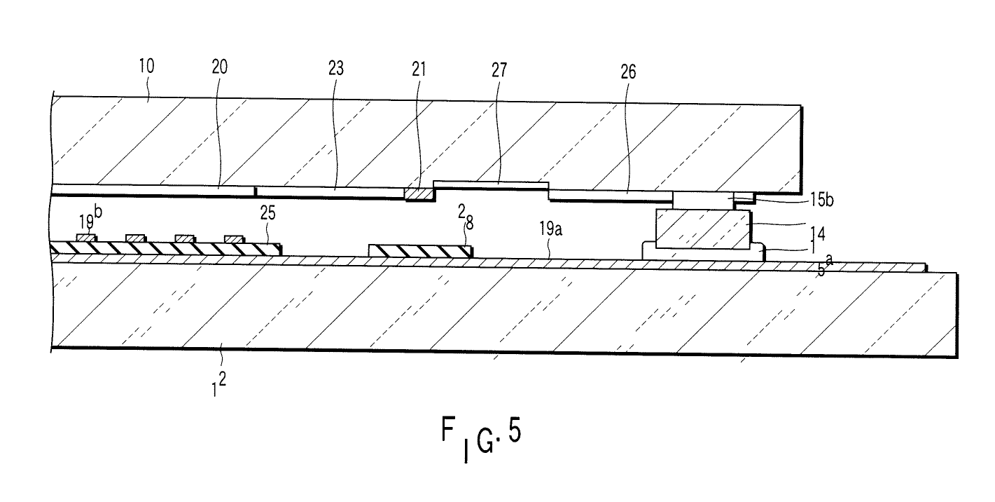

Thus, in this embodiment, a conducting part of the back-side substrate 12 opposite to the power supply wirings 21 and 21′ is covered by an insulating material, in order to prevent damage caused by an electric discharge occurring in the power supply wirings 21 and 21′. Hereinafter, an explanation will be given on a discharge control structure according to a first embodiment of the invention with reference to FIG. 5. In the following explanation, it is assumed that a dividing structure of the metal back 17 is a two-dimensional structure shown in FIG. 3.

As shown in FIG. 5, on the inside surface of the back-side substrate 12, lower wires 19a (scanning wires) intersect at right angles with upper wires 19b (signal wires), forming a matrix pattern, with an insulating layer 25 interposed between the wires 19a and the wires 19b. The lower wire 19a and upper wire 19b function as a driving wire 19 mentioned before to selectively apply a driving voltage to the electron-emitting element 18. The ends of lower wire 19a and upper wire 19b are brought to the outside of the vacuum enclosure 15 through a sealing part 15a, and connected to a not-shown driving circuit.

On the inside surface of the front-side substrate 10, a fluorescent screen 16 to function as an image display area 20 (a fluorescent screen) and a metal back 17 are formed. On the outside of the image display area 20, the frame-like power supply wiring 21 is formed through a plurality of connection resistors 23. The outside of the power supply wiring 21 forms a grounding area 26 through the sealing part 15b. A high resistance area 27 is connected between the power supply wiring 21 and grounding area 27. The configuration, up and down sides, of the power supply wiring 21 and grounding area 26 can be optionally changed, and is not an essential condition of the invention.

On the inside surface of the back-side substrate 12 opposite to the power supply wiring 21, an insulation layer 28 covering at least a part of the lower wire 19a is provided. The insulation layer 28 is provided at the position opposite to the power supply wiring 21 of the front-side substrate 10, and extended like a frame along the power supply wiring 21. Contrarily, if the lower wire 19a extended in the area opposite to the power supply wiring 21 is exposed, and an electric discharge occurs in this area, enormous discharge current from the power supply wiring 21 flows into the electron-emitting element 18 through the lower wire 19a, causing serious damage. Thus, in this embodiment, the insulation layer 28 is provided in the area opposite to the power supply wiring 21.

With this structure, emission of electron from the lower wire 19a of the back-side substrate 12 is controlled, and an electric discharge caused by the back-side substrate is prevented. Even if a discharge occurs in the front-side substrate or is caused by foreign matter, the influence of the discharge can be suppressed to some extent. Therefore, damage caused by the discharge can be suppressed.

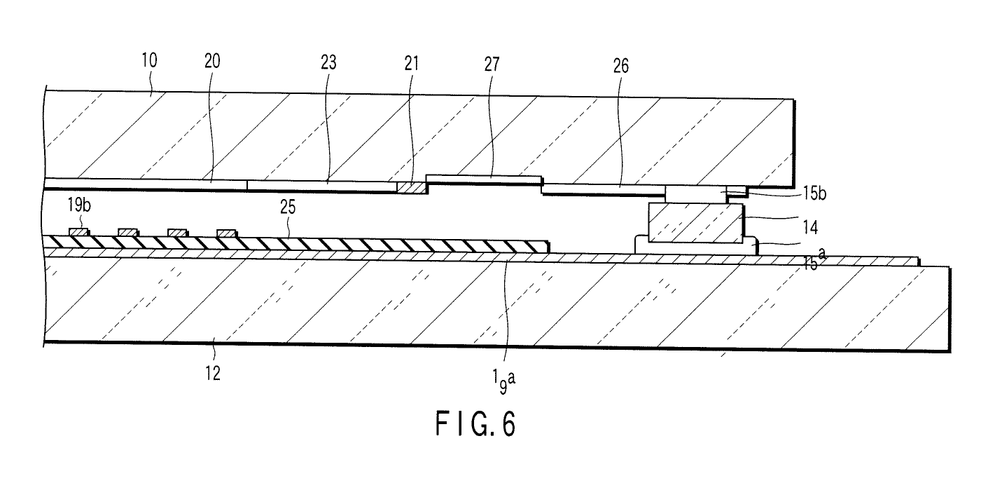

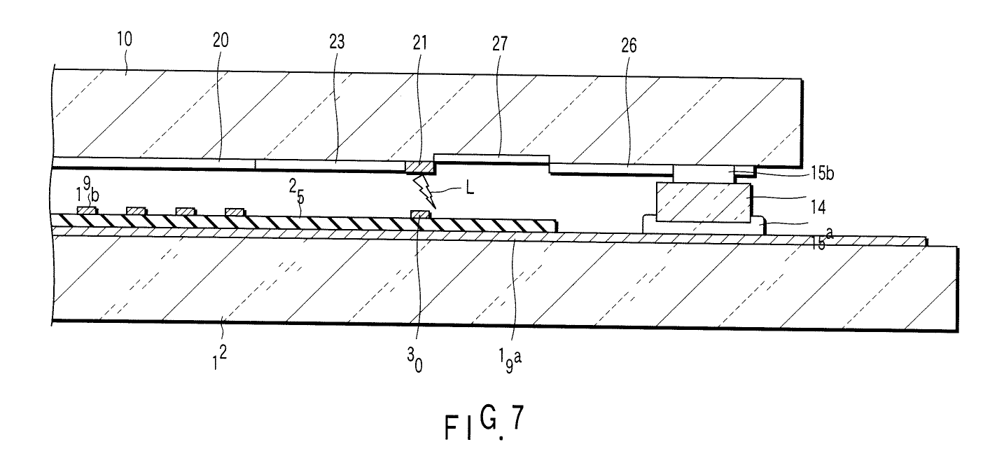

FIG. 6 shows a modification of the discharge control structure of the above first embodiment.

Here, an insulation layer 25 insulating the lower wire 19a and upper wire 19b is extended up to the area opposite to the power supply wiring 21. In this configuration, as in the above first embodiment, damage caused by a discharge can be prevented. As in the above first embodiment, the insulation layer 28 is desirably provided at least in the area opposite to the power supply wiring 21. However, by using the insulation layer 25 insulating the lower wire 19a and upper wire 19b as an insulation layer to control a discharge as in this modification, the process of manufacturing the SED 1 can be simplified.

As above described, according to the embodiment, as the insulation layer 25 (28) covering at least a part of the driving wire 19 is provided in the area of the back-side substrate 12 opposite to the power supply wiring 21 to supply a high voltage to the image display area 20 of the front-side substrate 10, a discharge between the power supply wiring 21 and driving wire 19 can be controlled, and damage caused by a discharge in this area can be prevented.

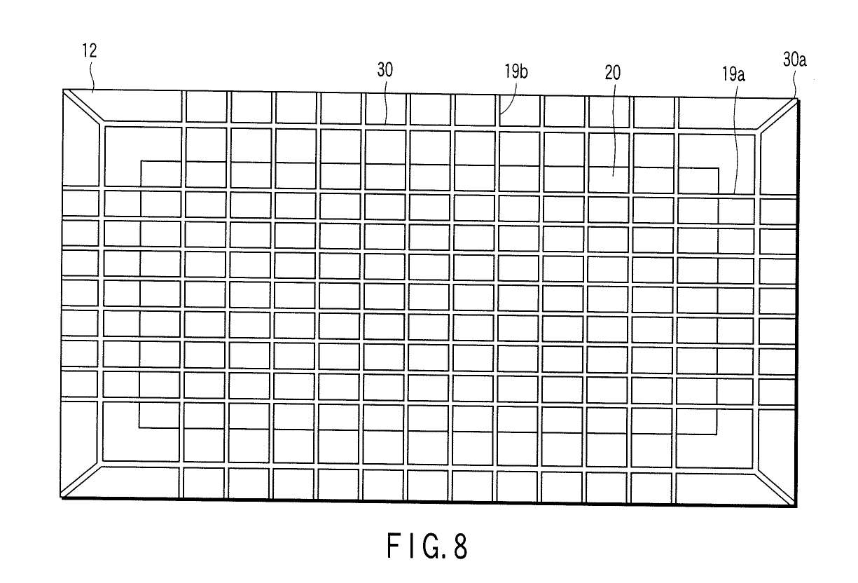

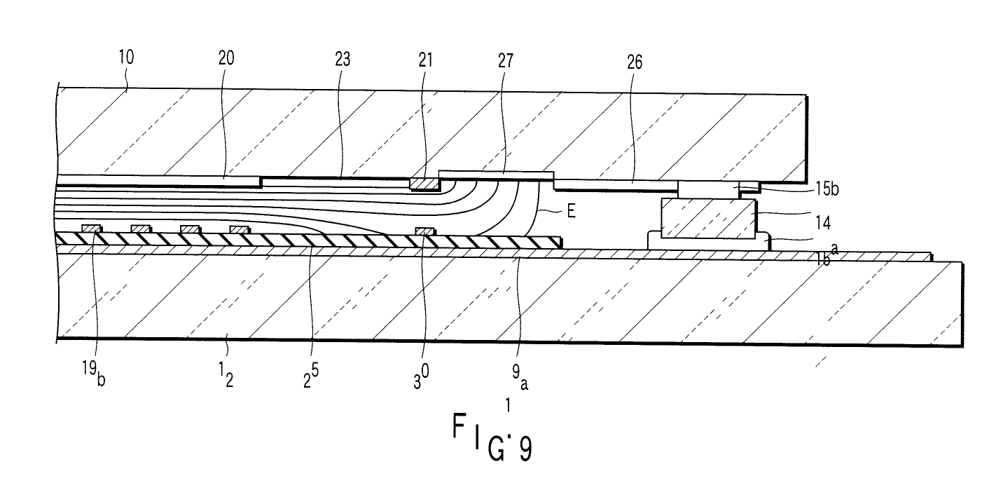

Next, an explanation will be given on a discharge control structure according to a second embodiment of the invention with reference to FIG. 7 and FIG. 8. In the structure of FIG. 7, the component having the same functions as those of the first embodiment structure are given the same reference numerals, and detailed explanation will be omitted. Namely, the discharge control structure of this embodiment is the same as that of the first embodiment, except a bypass member 30 provided as a lighting rod on the insulation layer 25 explained in FIG. 6.

As shown in FIG. 7, the bypass member 30 is provided electrically independent of the lower wire 19a in the area opposite to the power supply wiring 21. The position of the bypass member 30 may be substantially opposite to the power supply wiring, and the shape of the bypass member may be optional. The bypass member 30 is not necessarily provided opposite to all along the total length of the power supply wiring 21, and may be provided at least partially opposite to the power supply wiring. It is preferable to provide the bypass member like a frame along the power supply wiring 21, as shown in FIG. 8.

To make the bypass member 30 function as a lightning rod, it is necessary to provide the bypass member at the position closer to the power supply wiring 21 with respect to the driving wire 19. Further, as shown in FIG. 8, the bypass member 30 is grounded through the connection wiring 30a formed at four corners of the back-side substrate 12.

As described above, according to this embodiment, as the bypass member 30 is provided between the power supply wiring 21 and driving wire 19, when an electric discharge L occurs in the area of the power supply wiring 21, the bypass member 30 functions as a lightning rod, and a discharge current can escape to ground. Therefore, the driving wire 19 can be protected from an electric discharge, the amount of discharge current straying into the electron-emitting element 18 can be largely limited, and damage caused by an electric discharge can be prevented.

The invention is not limited to the embodiments described hereinbefore. The invention may be embodied by modifying the components without departing from the essential characteristics. Further, the invention may be embodied in other specific forms by combining the components disclosed in the above embodiments. For example, some components may be deleted from the components indicated in the above embodiments. The components of different embodiments may be combined.

For example, the bypass member 30 to function as a lightning rod is grounded in the second embodiment. However, the bypass member 30 is given an optional potential. For example, by giving the bypass member 30 a potential of the value between the potential in the image display area 20 and the potential in the driving wire 19, an electric field shown as an equipotential line E in FIG. 9 can be formed around the bypass member 30. According to FIG. 9, the equipotential line E is coarse in the area around the power supply wiring 21, compared with the area close to the image display area 20, and it is seen that the probability of electric discharge is decreased in the area around the power supply wiring 21.

In the second embodiment, the bypass member 30 electrically independent of the driving wire 19 is provided through the insulating layer 25 (28). However, the bypass member 30 for escaping a discharge current may be provided between the power supply wiring 21 and driving wire 19. The insulation layer 25 is not an essential element in the invention.

The insulation layer mentioned in this invention may be a layer in which an interlayer leak current is negligible, and includes a layer given a little conductivity to prevent static electricity. For example, a layer with a sheet resistance of approximately 109 Ω/□ is included.

The flat display unit according to the invention has the configuration and functions described hereinabove, and prevents damage caused by an electric charge occurring in an area of power supply wiring to apply potential to an image display area, at relatively low cost.

What is claimed is:

1. A flat display unit, in which a front-side substrate having on its inside surface a fluorescent screen including a fluorescent layer and divided metal backs formed on the fluorescent layer, power supply wiring arranged outside an image display area provided with the fluorescent layer, and a connection resistor for connecting the power supply wiring to the divided metal backs, is opposed to a back-side substrate having on its inside surface an electron-emitting element and a driving wire for driving the electron-emitting element, which are opposed across a predetermined clearance and sealed in the peripheral edge portion; and the interior is evacuated,
wherein an insulation layer to cover the driving wire is provided in an area of the back-side substrate opposite to the power supply wiring.

2. The flat display unit according to claim 1, wherein a bypass member is provided on the insulation layer.

3. The flat display unit according to claim 2, wherein the bypass member is grounded.

4. The flat display unit according to claim 2, wherein the bypass member is given a potential of magnitude between a potential in the image display area and a potential in the driving wire.
